(19) United States
(12) Patent Application Publication
(10) Pub. No.: US 2008/0223593 A1
(43) Pub. Date: Sep. 18, 2008

(54) HANDLE

(76) Inventors: Roswitha EICHER, Filderstadt (DE); Stefan Heess, Leinfelden-Echterdingen (DE); Joerg Maute, Sindelfingen (DE); Florian Esenwein, Uhingen-Holzhausen (DE); Bernhard Eicher, Filderstadt (DE); Marcus Schuller, Dettenhausen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/046,825

(22) Filed: Mar. 12, 2008

(30) Foreign Application Priority Data
Mar. 14, 2007 (DE) 10 2007 012 312.6

(51) Int. Cl. B25D 17/04; B23B 45/00

(52) U.S. Cl. 173/162.2; 173/109

(57) ABSTRACT

Disclosed is a handle including a grip element and a fastening element situated on the grip element; the fastening element protrudes at least partway into the grip element and is guided in the grip element with a radial play. The handle is characterized by means of at least one damping element that is situated on the grip element so that it functions as a stop for limiting the radial play of the fastening element in the grip element.

REFERENCE TO FOREIGN PATENT APPLICATION

This application is based on German Patent Application No. 10 2007 012 312.6 filed Mar. 14, 2007, upon which priority is claimed.

### BACKGROUND OF THE INVENTION

1. Field of the Invention

The invention relates to a handle, in particular an auxiliary handle, for a hand-guided power tool.

2. Description of the Prior Art

Numerous power tools such as angle grinders, drills, and rotary hammers are equipped with an auxiliary handle. In order to prevent vibrations generated during operation of the power tool from being transmitted to the operator via the auxiliary handle, auxiliary handles are usually provided with vibration-damping means.

DE 20 2004 012 400 U1 has disclosed a handle that is for a hand-guided power tool and is composed of a grip region, a fastening part, and an elastic intermediate piece situated between them. In addition, a stabilizing element is provided, which starting from the body of the hand-guided power tool, extends through the elastic intermediate element and into the grip region; the stabilizing element is guided with play in a guide of the grip region for preventing radial movements, but is able to move freely in the grip part in the axial direction of the stabilizing element.

### OBJECT AND SUMMARY OF THE INVENTION

The present invention is based on a handle equipped with a grip element and a fastening element that is situated on the grip element and is for attaching the handle to a housing of a hand-guided power tool. The fastening element protrudes at least partway into the grip element and is guided with a radial play in the grip element.

According to the present invention, at least one damping element is provided, which is situated on the grip element in such a way that it functions as a stop for limiting the radial play of the fastening element in the grip element. This has the advantage that on the one hand, the deflection of the handle under powerful stress is limited and on the other hand, upon maximum deflection of the handle, vibrations are transmitted from the fastening element to the grip element only in a damped fashion.

Preferably, a plurality of damping elements are situated along the longitudinal axis of the grip element and function as stops for limiting the radial play of the fastening element in the grip element. It is particularly advantageous in this case if the damping elements permit the fastening element differing degrees of radial play freedom that are greater the closer the damping element is situated to the free end of the grip element. In such an arrangement of a plurality of damping elements, the individual damping elements each serve as a stop at a different intensity of deflection of the handle. A first damping element, which is situated the closest to the hand-guided power tool when the handle is in the installed state on the hand-guided power tool, permits the least amount of radial play of the fastening element in the grip element. Even with a relatively small degree of deflection of the handle, the fastening element comes into contact with the first damping element. A second damping element, which is situated closest to the free end of the grip element is embodied so that it permits the greatest degree of radial play of the fastening element in the grip element. Consequently, the fastening element comes into contact with the second damping element only with a relatively large deflection of the handle, as a result of which the second damping element also functions in a vibration-damping fashion. In addition to the first and second damping elements, additional damping elements can be situated between the first and second damping elements in the axial direction of the handle; the additional damping elements correspondingly permit a greater degree of radial play freedom the closer the damping element is situated to the free end of the grip element.

The individual damping elements are situated resting against the inner wall of the hollow grip element and are preferably each embodied in the form of a ring, a sleeve, or the like. In lieu of being embodied in the form of a ring, a sleeve, or the like, one or more damping elements can also have a contour, e.g. in the form of a notch, groove, or the like.

If a plurality of damping elements are provided, which each permit a different degree of radial play freedom, then the differing degrees of radial play freedom can be achieved by providing different-sized gap widths between the fastening element and damping elements. The gap width thus increases in the axial direction toward the free end of the grip element.

Alternatively, differing degrees of radial play freedom can also be achieved by providing the damping elements with different intensities of damping action. If the damping elements are composed, for example, of an elastomer material, then it is possible to select the elasticity of the individual damping elements in a corresponding fashion so that the first damping element has a comparatively low elasticity while the second damping element has a comparatively high elasticity.

It is advantageous if the position of the damping element is adjustable along the longitudinal axis of the handle. For example, this can be implemented by providing the damping elements and the inner wall of the cavity with a thread that permits the damping elements to be screwed into a desired position in the axial direction of the grip element. The adjustability of the axial position of the damping elements makes it possible for the operator to adapt the vibration-damping properties of the handle to the respective use.

Alternatively, in lieu of a plurality of individual damping elements, it is also possible to provide only a single damping element, which extends along the longitudinal axis of the grip element. It likewise rests against the inner wall of the hollow grip element and preferably is embodied in the form of a sleeve, a tube, or the like. In order to permit differing degrees of radial play freedom along the longitudinal axis of the grip element, the inner diameter of the damping element increases in the axial direction toward the free end of the grip element. This means that the cavity in the damping element widens out conically toward the free end of the grip element.

The at least one damping element can be composed of an elastic material, e.g. an elastomer or a foam. It can also be a damping cushion filled with a fluid, e.g. a gas, a liquid, or a gel. It is also possible to use damping elements in the form of springs, e.g. helical springs or leaf springs. These can be embodied with different elasticities in order to permit differing degrees of radial play freedom in the axial direction of the grip element.

The grip element of the handle according to the present invention has an essentially cylindrical form. In a simple embodiment, it can be a cylinder. The cylindrical grip casing can also be adapted to the ergonomics of the human hand in that, by contrast with a purely cylindrical shape, it has varying diameters along its longitudinal axis, for example, and is thus bulbous or convex. The grip element here can be rotationally symmetrical so that the handle can be grasped at any orientation in relation to the operator. Alternatively, the grip element can also be especially adapted to the ergonomics of the human hand so that a first region of the grip element specifically serves as a support surface for the palm and a second region serves as a support surface for the fingers.

In addition, the grip element can be of a one-part or multipart embodiment. A multipart grip element can, for example, also have a grip casing, which can simultaneously function in a vibration-damping fashion.

The handle according to the present invention can also be equipped with other vibration-damping means, e.g. an absorbing mass.

The fastening element is used to detachably fasten the handle to a housing of a hand-guided power tool. In a simple embodiment, the fastening element can be a kind of threaded bolt that can be screwed into the housing of the hand-guided power tool. The threaded bolt protrudes out from the grip element with a part of the shaft that is provided with a thread. The remaining part of the shaft is situated preferably centrally in the cavity of the grip element and extends, for example, over half the length or the entire length of the grip element. In lieu of a thread, the fastening device on the fastening element can also be provided in the form of a clamping device, for example, which permits the handle to be clamped to the housing of a hand-guided power tool.

The fastening element can be of a one-part or multipart embodiment. A two-part fastening element is composed, for example, of a fastening device and a support element; the fastening device can, for example, be a screw connection device, e.g. a threaded bolt, a screw, or the like, or can be a clamping device. The fastening device is situated on the support element, e.g. by virtue of a threaded bolt being partially extrusion coated with plastic that constitutes the support element. The support element for the fastening device in this case constitutes the head of the handle and is oriented toward the hand-guided power tool when the handle is in the installed position on the housing of a tool. In such an embodiment, an additional vibration-damping means, e.g. in the form of an elastic material, can be provided, for example, between the support element of the fastening element and the grip element.

The handle according to the present invention is particularly suited for use as an auxiliary handle for a cordless or corded hand-guided power tool such as an angle grinder or rotary hammer. Consequently, a hand-guided power tool that has a handle according to the present invention is an additional subject of the present invention.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a longitudinal section through a schematic depiction of all embodiment of a handle according to the present invention, and

FIG. 1a shows an enlarged detail from a modified embodiment of the damping element 30.

### DESCRIPTION OF THE PREFERRED EMBODIMENTS

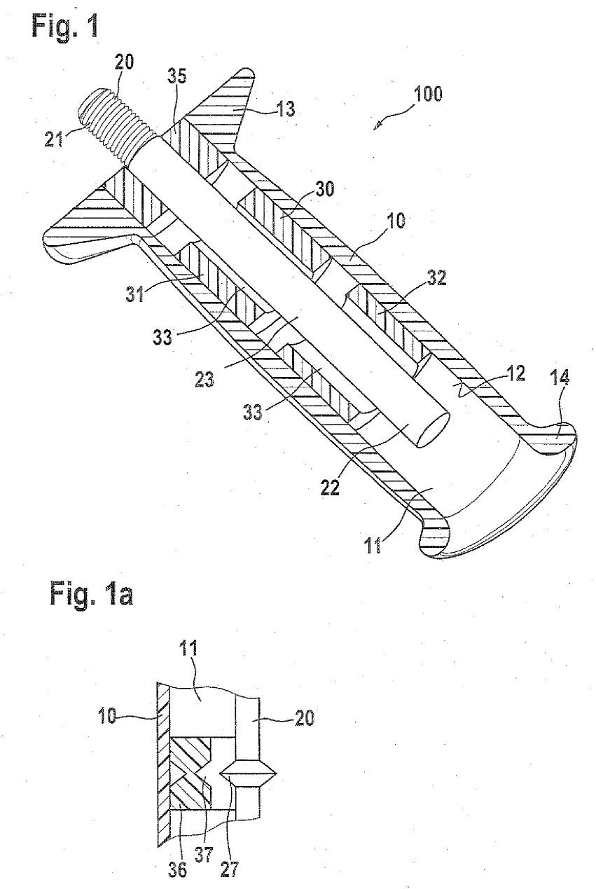

The handle 100 depicted in FIG. 1 is particularly suited for use as an auxiliary handle for a hand-guided power tool such as an angle grinder, a drill, or a rotary hammer. The handle 100 has a grip element 1O, which in the embodiment shown is embodied as hollow over its entire length. The cavity is labeled with the reference numeral 11 in FIG. 1. The grip element 10, at an end oriented toward the hand-guided power tool when mounted on the hand-guided power tool, is provided with a collar-like flare 13 that serves to prevent slippage. At this end of the handle 100, a fastening element 20 protrudes from the grip element 10. The fastening element 20 is used to attach the handle 100 to a housing of a hand-guided power tool (not shown). For this purpose, the end 21 protruding out from the grip element 10 is provided, for example, with a thread, not shown in greater detail, with which the handle 100 can be screwed into the housing of the hand-guided power tool. In lieu of a thread, the free end 21 can also be provided with a clamping device, as is fundamentally already known from the prior part.

The opposite end 22 of the rod-shaped fastening element 20 protrudes into the grip element 10, with the shaft 23 situated essentially centrally in the hollow grip element 10. The fastening element 20 is guided in the grip element 10 with a radial play.

According to the present invention, at least one damping element 30 is provided, which is situated on the grip element 10 so that it functions as a stop to limit the radial play of the fastening element 20 in the grip element 10. In the embodiment shown, two damping elements 31, 32 are situated on the inner wall 12 of the hollow grip element 10, arranged one after another in the axial direction of the handle 100. The damping elements 31, 32 perform the function of a radial stop and the function of a vibration-damping means as soon as the fastening element 20 comes into contact with the damping elements 31, 32 when the handle 100 is deflected. The damping elements 31, 32 are embodied so that they permit the fastening element 20 different degrees of a radial play freedom, with the first damping element 31 permitting the end 21 of the fastening element 20 that is oriented toward the hand-guided power tool in the installed state less play freedom than the second damping element 32, which is situated the closest to the free end 14 of the grip element 10. The radial play freedom of the damping elements 31, 32 thus increases in the direction toward the free end 14 of the grip element 10. In this way, it is also possible for more than two damping elements 30 to be provided in the grip element 10 (not shown). Due to the differing degrees of radial play freedom, the damping elements 31, 32 serve as stops at different degrees of deflection of the handle 100. Thus the fastening element 20 comes into contact with the first damping element 31 even with a relatively small degree of deflection of the grip element 10, while the fastening element 20 only comes into contact with the second damping element 32 with a relatively high degree of deflection, then exerting a vibration-damping action in addition to the first damping element 31.

The damping elements 31, 32 according to FIG. 1 are each embodied in the form of a ring, a sleeve, or the like. The radial play freedom is determined by the fact that a gap 33 is situated between the fastening element 20 and each damping element 31, 32; the width of the gap 33 at the first damping element 31 is less than at the second damping element 32. The width of the gap therefore increases in the axial direction toward the free end 14 of the grip element 10 in order to increase the degree of radial play freedom in this direction.

Alternative to the annular shape or sleeve shape of the damping elements 31, 32 depicted in FIG. 1, FIG. 1a shows an enlarged detail from a modified embodiment of the damping element 30. The damping element 36 is provided with a contour 37. The contour 37 according to FIG. 1a has a notch. Correspondingly, the shaft 23 of the fastening element 20 has a radially protruding lug 27 with a form corresponding to that of the contour 37. Through an appropriate selection of the contour 37 of the damping element 36, it is possible to influence the damping properties.

An additional damping element 35, e.g. composed of an elastomer, is situated between the grip element 10 and the fastening element 20 at the end of the grip element 10 oriented toward the hand-guided power tool in the installed state.

The foregoing relates to preferred exemplary embodiments of the invention, it being understood that other variants and embodiments thereof are possible thin the spirit and scope of the invention, the latter being defined by the appended claims.

We claim:

1. A handle comprising an elongated, generally hollow cylindrical grip element, a fastening element situated on the grip element and protruding at least partway into and guided in the grip element with a radial play, and at least one damping element situated on the grip element so that it functions as a stop for limiting the radial play of the fastening element in the grip element.

2. The handle as recited in claim 1, comprising a plurality of damping elements situated along the longitudinal axis of the grip element and functioning as stops for limiting the radial play of the fastening element in the grip element.

3. The handle as recited in claim 2, wherein the damping elements each permit a different degree of radial play freedom, which is greater the closer the damping element is situated to the free end of the grip element.

4. The handle as recited in claim 3, further comprising a gap between each damping element and one of the grips element or the fastening element, and wherein the gaps between the fastening element and the damping elements are of different widths to thereby permit a different degree of radial play.

5. The handle as recited in claim 3, wherein the damping elements each permit a different degree of radial play freedom in that they each have a different intensity of damping action.

6. The handle as recited in claim 4, wherein the damping elements each permit a different degree of radial play freedom in that they each have a different intensity of damping action.

7. The handle as recited in claim 2, wherein the position of the damping element is adjustable along the longitudinal axis of the handle.

8. The handle as recited in claim 3, wherein the position of the damping element is adjustable along the longitudinal axis of the handle.

9. The handle as recited in claim 4, wherein the position of the damping element is adjustable along the longitudinal axis of the handle.

10. The handle as recited in claim 5, wherein the position of the damping element is adjustable along the longitudinal axis of the handle.

11. The handle as recited in claim 6, wherein the position of the damping element is adjustable along the longitudinal axis of the handle.

12. The handle as recited in claim 1, wherein the at least one damping element is composed of an elastic material.

13. The handle as recited in claim 2, wherein the at least one damping element is composed of an elastic material.

14. The handle as recited in claim 3, wherein the at least one damping element is composed of an elastic material.

15. The handle as recited in claim 5, wherein the at least one damping element is composed of an elastic material.

16. The handle as recited in claim 6, wherein the at least one damping element is composed of an elastic material.

17. The handle as recited in claim 7, wherein the at least one damping element is composed of an elastic material.

18. The handle as recited in claim 1, wherein the at least one damping element is a damping cushion filled with a fluid.

19. The handle as recited in claim 4, wherein the at least one damping element is a damping cushion filled with a fluid.

20. A hand-guided power tool equipped with a handle as recited in claim 1.
